(19) United States
(12) Patent Application Publication
(10) Pub. No.: US 2014/0250402 A1
(43) Pub. Date: Sep. 4, 2014

(54) EFFICIENT INPUT MECHANISM FOR A COMPUTING DEVICE

(71) Applicant: MICROSOFT CORPORATION, Redmond, WA (US)

(72) Inventor: Jason Lee Van Eaton, Bothell, WA (US)

(73) Assignee: Microsoft Corporation, Redmond, WA (US)

(21) Appl. No.: 13/863,356

(22) Filed: Apr. 15, 2013

Related U.S. Application Data
(60) Provisional application No. 61/772,511, filed on Mar. 4, 2013.

(51) Int. Cl. G06F 3/0488; G06F 3/0482

(52) U.S. Cl. CPC G06F 3/04886; G06F 3/0482
USPC 715/773; 715/810; 715/834

(57) ABSTRACT

The subject disclosure is directed towards technology that provides an input mechanism for efficient navigation on a computing device. The input mechanism may include a cell-based input mechanism for displaying a display pattern having a central portion and a peripheral portion on which input cells are configured. When a stroke begins at a position on the peripheral portion that corresponds to a desired page and ends at the central portion, the cell-based input mechanism modifies the input cells on the display pattern to display input cells for the desired page.

### CROSS-REFERENCE TO RELATED APPLICATION

The present application claims priority to U.S. Provisional Patent Application Ser. No. 61/772,511, filed Mar. 4^{th}, 2013.

### BACKGROUND

As computers have become more complex, user interfaces have had to adapt to allow the user to control the operations of the computer. One example interface includes the Graphical User Interface (“GUI”), which allows users to point to objects, buttons, and windows displayed like items on a desk. Various devices enable input, navigation, and control of such an interface of which a pointing device and a keyboard-based input device are typically associated with conventional computing systems, such as desktop and laptop computers. The keyboard-based interface enables a user to navigate through applications, control operations associated with those applications, and input text while using the keyboard.

Mobile computing devices in today's society are associated with problems related to user interface size and functionality constraints, including those problems related to keyboard-based interfaces. A standard keyboard comes with a set of one-hundred and two (102) keys, but many keyboards provide additional keys for launching or controlling the browser, media player, volume, etc. Given that the keyboard-based interface cannot fit all or most keyboard keys on a single interface page, these keys may be divided up and grouped together into logical collections. Designing a user interface capable of providing a user with efficient access to such keys without confusing or overwhelming that user is a difficult task given that today's market desires smaller and smaller computing devices.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a cell-based input mechanism that provides efficient navigation between pages. A page may be defined as a logical configuration of input cells operating as a user interface feature through which a user inputs data values, text, commands, and/or the like via interaction with those input cells. In one aspect, the cell-based input mechanism configures a display pattern to display page indicia on a portion comprising touchable zones.

A number of textual input mechanisms exist for mobile and wearable computing devices, such as multi-tap, T9, Palm Graffiti and/or the like. These technologies are frequently hardware specific. The mechanism described herein enables input and navigation with faster speed, fewer keystrokes and less fatigue. Example implementations of this mechanism allow the user to navigate between pages while minimizing the need for the user to lift his or her finger/stylus. Using this mechanism, for instance, the user can lift a finger from entering a last input cell, touch down in a zone representing the page to which the user desires to switch, and then drag that value into a central portion of the display pattern where the user is in position to select input cells on the desired page without lifting the finger.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a diagrammatic representation of an example display pattern for a cell-based input mechanism in accordance with one or more example implementations.

FIGS. 2A-2F illustrate various pages that are configured on an example computing device in accordance with one or more example implementations.

FIG. 3 is a block diagram illustrating an example computing device having a cell-based input mechanism in accordance with alternative implementations.

FIG. 4 is a flow diagram illustrating example steps for efficient navigation between pages in accordance with one or more example implementations.

FIG. 5 illustrates an example of a suitable non-limiting mobile device on which aspects of the subject matter described herein may be implemented.

### DETAILED DESCRIPTION

Various aspects of the technology described herein are generally directed towards a computing device that enables gesture-based navigation according to one example implementation. It is appreciated that terms, such as “gesture”, “stroke” and/or “swipe” may be used interchangeably in certain contexts. As described herein, with a single gesture/stroke, a user may select a particular page for inputting data in a particular format; then, the user may proceed to input text or textual commands in that desired format. The user may select a different page in substantially the same manner.

A cell-based input mechanism for the computing device generates a display pattern having a first portion and a second portion such that a stroke beginning at a position on the first portion and ends at the second portion indicates a page change. The cell-based input mechanism may employ an interface, such as Natural User Interface (NUI), to recognize the user's stroke. NUI may generally be defined as any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other categories of NUI technologies include touch sensitive displays, voice and speech recognition, intention and goal understanding, motion gesture detection using depth cameras (such as stereoscopic camera systems, infrared camera systems, RGB camera systems and combinations of these), motion gesture detection using accelerometers/gyroscopes, facial recognition, 3D displays, head, eye, and gaze tracking, immersive augmented reality and virtual reality systems, as well as technologies for sensing brain activity using electric field sensing electrodes.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing device interfaces in general.

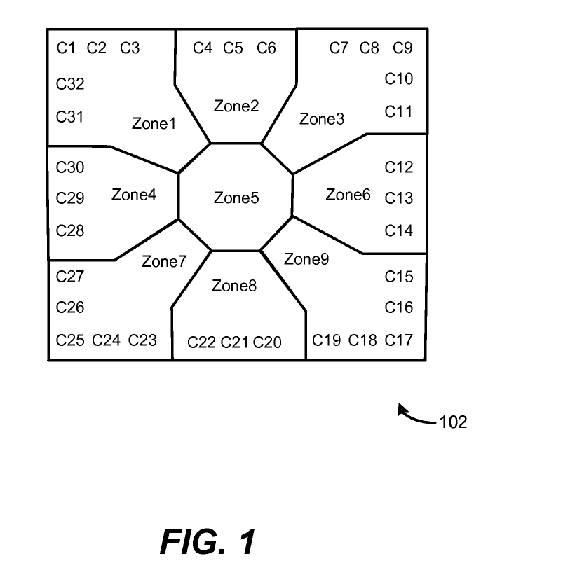

FIG. 1 is a diagrammatic representation of an example display pattern 102 for a cell-based input mechanism in accordance with one or more example implementations. FIG. 1 illustrates one example embodiment in which a first portion is substantially centered in the example display pattern 102 and a second portion is positioned around a periphery of the first portion. Hence, with respect to the description of FIG. 1, the first portion and the second portion of the example display pattern 102 may be referred to as a central portion and a peripheral portion, respectively. It is appreciated that other embodiments may position the first portion and the second portion differently.

As illustrated, the example display pattern 102 comprises the first portion and the second portion on which a configuration of zones operate. Each zone refers to a collection of interactive positions on the first portion and/or the second portion. As illustrated, zones labeled “Zone1”, “Zone2”, “Zone3”, “Zone4”, “Zone6”, “Zone7”, “Zone8” and “Zone9” represent at least part of the second portion; and a (center) zone labelled “Zone5” represents at least part of the second portion. Although the first portion includes the zone “Zone5”, other embodiments may provide a display pattern without implementing the first portion as a zone.

An arrangement of input cells, configured around the periphery of the second portion, characterize a page for input processing. Each input cell in FIG. 1 is labelled with a “C” followed by a number. It is appreciated that the subject matter described herein is not limited to having the set of input cells on the second portion. The cell-based input mechanism may configure the set of input cells to operate on the first portion instead and use the second portion for displaying zones and/or page indicia.

Pages may be configured for inputting lowercase letters, uppercase letters, symbols, numbers, navigation/editing (nav/edit) operations, keyboard function keys, commands, custom commands/text, and so forth. Pages also may be configured for operating an interface device (e.g., a mouse, a keyboard, speech recognizer, a handwriting recognizer), for example, to input data/commands into the computing device, to remotely control a larger display device, and/or the like. To illustrate one example of page navigation, consider that the example computing device initially may be set to the lowercase letters page where each input cell either corresponds to a lowercase letter (e.g., “a”, “b”, and so forth) or a textual operation (e.g., backspace and/or the like). One example display pattern 102, therefore, enables at least thirty-two different input cells to be displayed around the periphery of the second portion.

To navigate between different pages, a user may initiate a stroke by touching a zone corresponding to a desired page and dragging to the first portion. Page indicia for the desired page may be displayed on the corresponding zone. By way of example, the page indicia for a letters page may be displayed as “Letters” on the corresponding zone. When the user's stroke ends at the first portion, the display pattern 102 transforms the second portion to display a different set of input cells. The user, while continuously touching the display pattern 102, proceeds to input data by moving to different zones and selecting a series of input cells.

It is appreciated that while some of the pages may be pre-defined (e.g., a numbers page), other pages may be customized. The user, for instance, configures a zone to display page indicia for a new page and via the cell-based input mechanism, arranges a set of input cells for the new page around a periphery of the display pattern 102. The cell-based input mechanism may be configured to process input cells from a different input mechanism (e.g., a larger display) and project those input cells onto the display pattern 102 as the new page's input cells.

It is further appreciated that the user may modify one of the pre-defined pages by, for example, moving input cells to different cell locations and/or replacing one or more input cells with other forms of input. To illustrate, the user may move a specific character (e.g., “$”) from an input cell location on one zone (e.g., zone four) to another input cell location on another zone (e.g., zone eight). The user also may add a custom character as an input cell on an unused cell location.

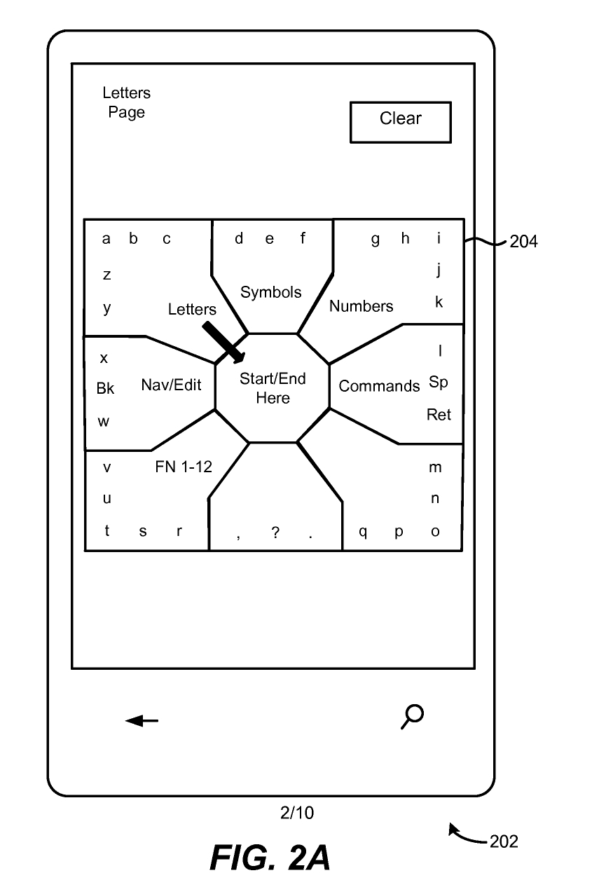

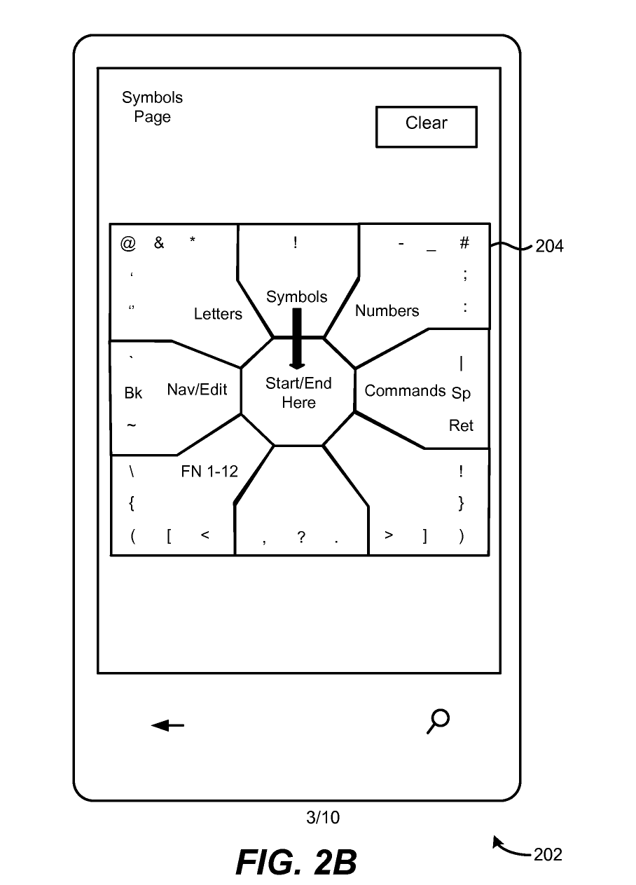

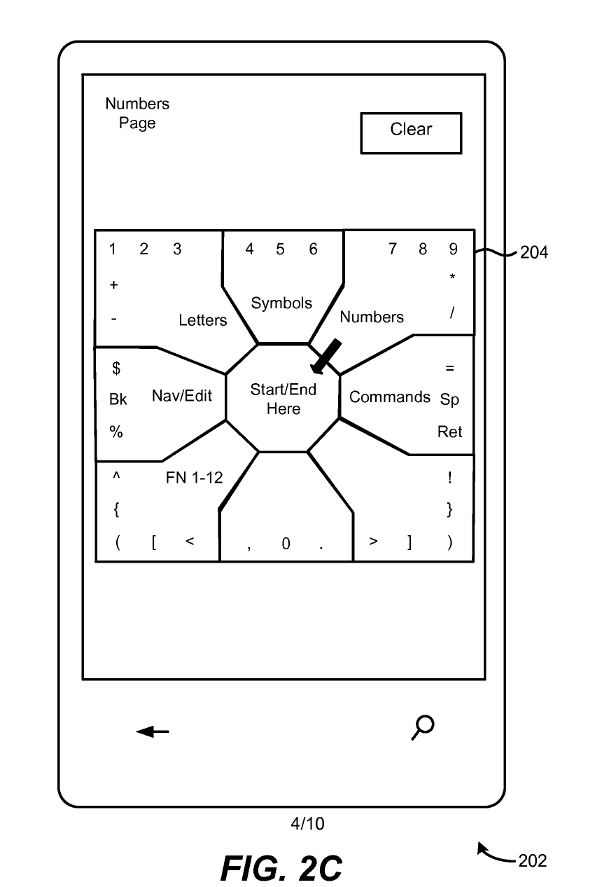

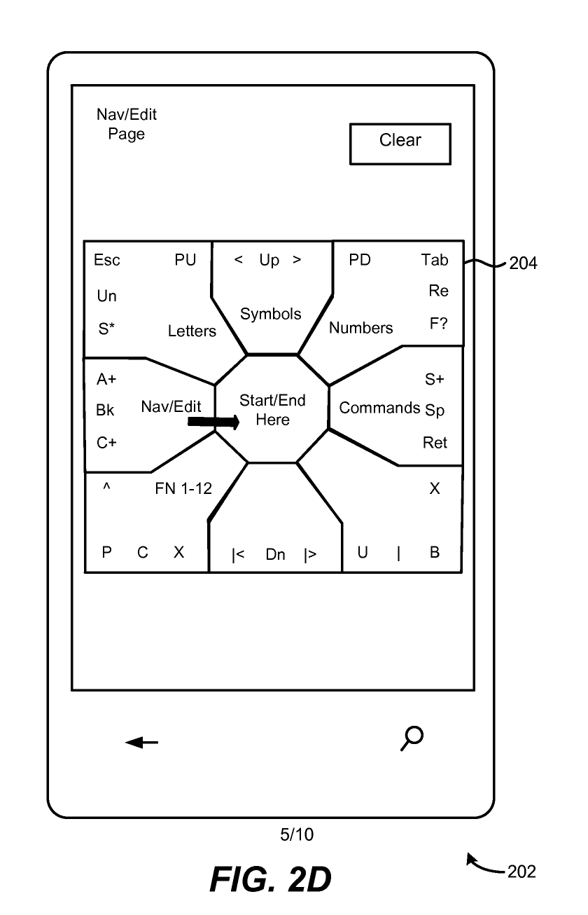

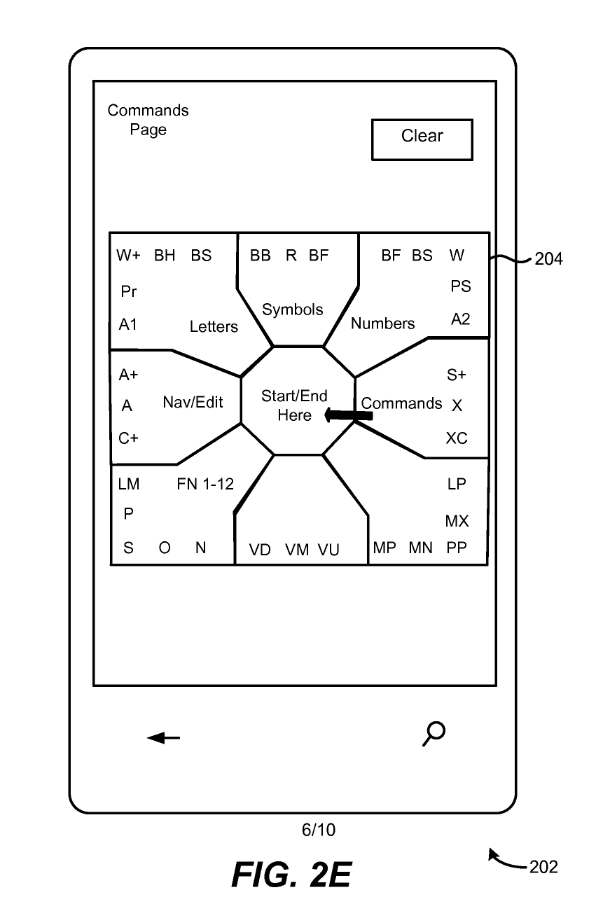

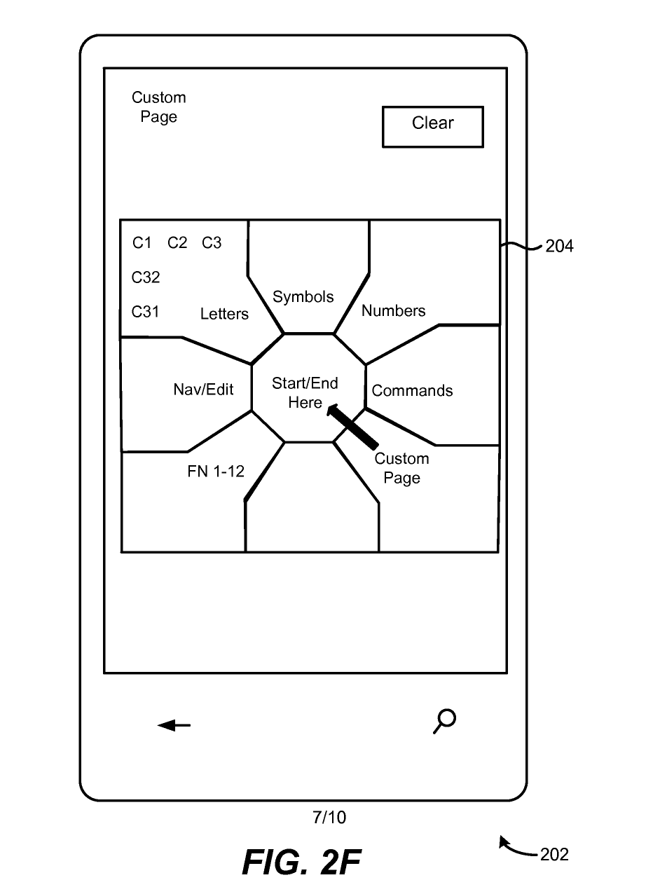

FIGS. 2A-2F illustrate various pages that are configured on an example computing device 202 in accordance with one or more example implementations. Although FIGS. 2A-2F depict a mobile device, it is appreciated that the display pattern embodied thereon can be utilized in any device with a touchable/gesture-based screen, including wearable computing devices, set-top boxes, remote controls, phones, mini-computers, and/or the like.

Inputting data via the various pages described herein enables the user to operate a larger display device in addition to, or instead of, interacting with the example computing device 202. These pages, for example, function as an interface to an operating system desktop of a remote computer. The example computing device 202 may be communicably coupled to the remote computer via a communication protocol (e.g., a wired or wireless network, a general purpose radio and/or the like). By using at least some of these pages, the user may control different applications running on the remote computer.

The example computing device 202 includes a touch-based combination input and navigation mechanism that features input cells arranged into zones (e.g., nine (9) zones). FIGS. 2A-2F depict at least a portion of a cell-based input mechanism 204 configured to navigate between pages. In one example implementation, a page is a collection of nine (9) zones arranged in a three by three (3×3) configuration starting with zone one (1) in the top left corner and zone nine (9) in the bottom right corner. The corner zones support five (5) input cells, while the middle/side zones support three (3) input cells, for a total of thirty-two (32) cells per page. It is appreciated that other embodiments are capable of configuring at least thirty-two (32) cells per page. The term ‘cells’ may include ‘keys’, which refer to the buttons on a keyboard, even though an input cell may represent multiple keys on a keyboard (e.g. Ctrl-C) or a sequence of inputs (e.g., a recorded macro).

The example computing device 202 may support multiple pages in which each page refers to a specific set of input cells arranged around a peripheral portion of an example display pattern. Some embodiments position a page's input cells on the peripheral portion in the form of a ring. FIG. 2A is a representation of one example computing device 202 of which the example display pattern enables efficient navigation to a lowercase letters page according to one example implementation. When a stroke begins at a zone having page indicia “Letters” (e.g., zone one) and ends at a central portion of the example display pattern, the computing device 202 detects that a user selected the lowercase letters page and configures a set of corresponding input cells for operation on the example display pattern. The user may proceed to input text in that desired lowercase letter format. The user may select a different page in substantially the same manner as described herein.

Using the cell-based input mechanism 204, the user may transform the lowercase letters page into a symbols page, which is illustrated in FIG. 2B, by touching a zone having page indicia “Symbols” (e.g., zone two) and dragging a finger/stylus to the central portion. FIG. 2B denotes the above described stroke with an arrow commencing at an upper middle zone of the peripheral portion and ending at the central portion. After such a page change, the user moves his/her finger to a zone configured with the desired symbol as an input cell.

One example implementation changes the example display pattern to display a symbols page for the purpose of entering one symbol. When the user moves or lifts his/her finger from the central portion after inputting a desired symbol, the example display pattern reverts back to the lowercase letters page. The user may move towards a zone (e.g., zone one (1)) configured with a “@” symbol, such as when entering an email address, and move back to the central portion “Start/End Here”, causing the example display pattern to transform the symbols page back to the lowercase letters page. As another example, if the user desires to enter an “&” symbol, the user's interaction with the cell-based input mechanism 204 begins at the central portion, proceeds to a first zone (e.g., zone one (1)) configured with the “&” symbol, continues to a second zone (e.g., zone two (2)) corresponding to the “&” symbol's position on the first zone and returns to the central portion in order to complete the “&” symbol's input. Once completed, the example display pattern reverts back to the lowercase letters page.

According to one example implementation, the computing device 202 transforms the lowercase letters page being displayed on the example display pattern into a numbers page—an example of which is illustrated in FIG. 2C—when a stroke is detected that starts from a zone having page indicia “Numbers” and ends at the central portion. To lock the numbers page's display on the example display pattern, the user repeats this stroke on the cell-based input mechanism 204. This may be performed when entering more than one number is desired. To revert back to the lowercase letters page after entering a sequence of numbers, the user repeats the above described stroke yet again. By way of example, the user may input text using lowercase letters until a number is required, such as when the user enters contact information by using letters for a name and numbers for a mobile phone number. In order to accomplish page navigation to the numbers page with a single stroke/gesture, the user touches the upper right zone corresponding to the numbers page (e.g., zone three (3)) and moves towards the central portion “Start/End Here” and then, releases his/her finger/stylus. The user repeats the above stroke to lock the display of the numbers page on the display pattern. After inputting multiple numbers, the user returns to the lowercase letters page by performing the above stroke for a third time. An arrow illustrates the above described stroke in FIG. 2C. As one alternative to repeating the above stroke, the user performs a stroke starting at the upper left zone corresponding to the lowercase letters page (e.g., zone one (1)) and ending at the central portion (e.g., zone five (5)) to return to the lowercase letters page.

Continuing with the above described example, the user enters numbers until another page is desired, such as when the user wants to navigate to another contact data field using a TAB operation on a navigation page. Upon touching a zone (e.g., zone four(4)) displaying “Nav/Edit” page indicia and dragging the finger/stylus towards the central portion, the cell-based input mechanism 204 transforms the example display pattern into the navigation page, as illustrated by an arrow on FIG. 2D, in a single stroke. The user may want to navigate to a next page of a document being displayed on a larger display device. In order to move up a page, the user touches an upper left zone (e.g., zone one (1)) with an input cell labeled “PU” for a page up operation, drags a finger/stylus towards an upper right zone (e.g., zone three (3)) corresponding to the “PU” input cell's position on the upper left zone and then, proceeds to the central portion.

FIG. 2E illustrates one example implementation of the computing device 202 in which a commands page is configured on the cell-based input mechanism 204. An arrow represents a stroke starting at a zone having page indicia “Commands” (e.g., zone six (6)) and ending at the central portion that instructs the cell-based input mechanism 204 to display the commands page. When operating a larger display, for instance, the user may open an application portal (e.g., a start menu) by selecting an input cell labeled “W” (e.g., a Microsoft® Windows® key) on an upper left zone (e.g., zone three (3)). In one example implementation, the user may replace default commands with custom commands, such as a command to open a favorite desktop application on the larger display device.

FIG. 2F illustrates a new page configured on the example display pattern according to one example implementation. Indicia for the new page, “Custom Page”, is depicted on a lower right zone (e.g., zone nine (9)) and input cells “C1”, “C2”, “C3”, “C32” and “C31” are configured on the upper left zone (e.g., zone one (1)). These input cells may represent any combination of custom commands, custom functions, recorded macros, custom text and/or the like. An arrow denotes a stroke for selecting the new page that begins at the lower right zone and ends at the central portion. It is appreciated that FIG. 2F merely illustrates one example new page and other customized pages may include more input cells (e.g., thirty-two (32) cells).

One example benefit of the approach described in this example is that at least thirty-two (32) input cell locations on a page can be used for actual values. Another example benefit is that input cell locations do not have to be reserved for pages. Some input and navigation mechanisms may support fewer input cells per page by reserving input cell locations for page changes, which decreases the number of input cells for textual input, commands and/or the like.

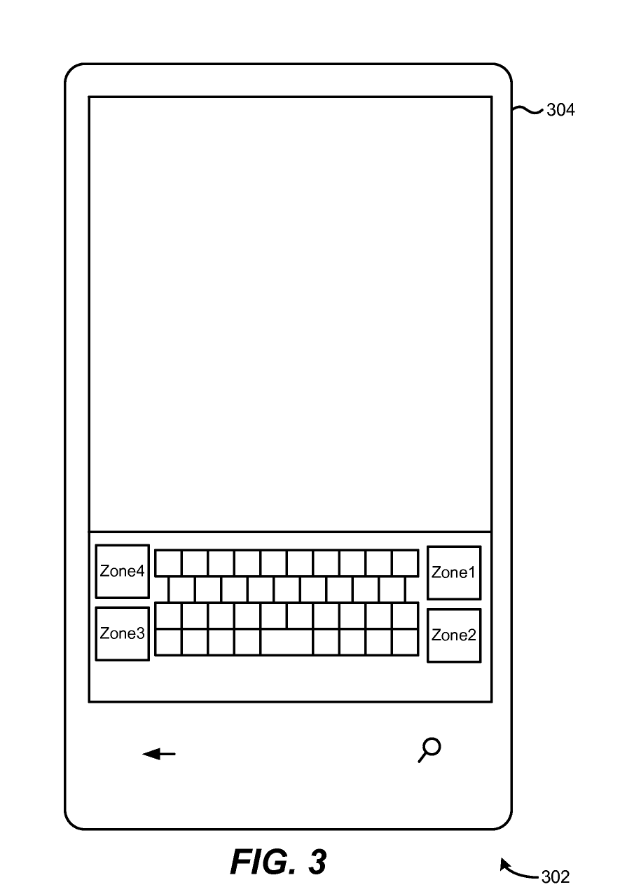

FIG. 3 is a block diagram illustrating an example computing device having a cell-based input mechanism in accordance with one or more alternative implementations. As illustrated, the cell-based input mechanism displays an example display pattern having a central portion. Input cells for the cell-based input mechanism substantially correspond to keys on a keyboard or a numeric keypad. The example display pattern arranges zones reserved for navigating between pages around a periphery of the central portion. These zones may be herein referred to as a zones display portion of the example display pattern. When the cell-based input mechanism on a computing device 302 detects a stroke that begins at one of these zones and ends at a position within the central portion, the computing device 302 modifies the cell-based input mechanism to display a desired page.

The input cell where the stroke pauses/ends may be processed as a first input on the desired page. For instance, if a numbers page is currently displayed and the user desires an uppercase letters page, the user touches zone “Zone1” causing a transformation from the numbers page to the uppercase letters page. The user's stroke/swipe proceeds to an input cell for an uppercase letter (e.g., “R” keyboard key), and if desired, continues to stroke/swipe additional input cells to input other uppercase letters. In some implementations, the example display pattern changes to a lowercase letters page and the user proceeds to stroke/swipe input cells that input lowercase letters until another page is desired. In some cell-based input mechanism implementations, the uppercase letters page is reverted back to the numbers page and the user's stroke/swipe proceeds to input numbers until another page is desired.

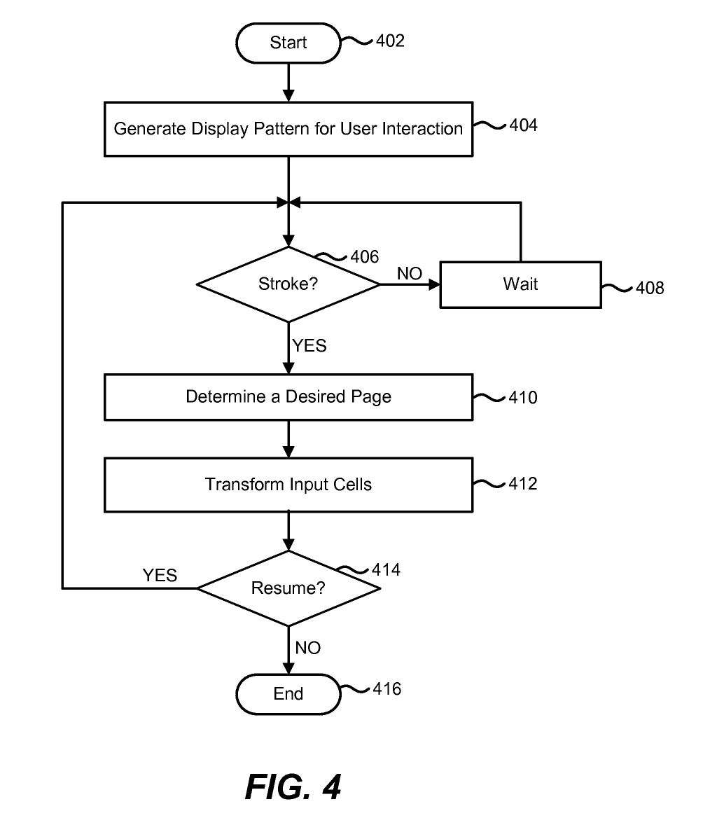

FIG. 4 is a flow diagram illustrating example steps for efficient navigation between pages according to one example implementation. One or more hardware/software components of a computing device may be configured to perform the example steps described herein. These components, when executed, may operate as at least a portion of a cell-based input mechanism. Step 402 commences the example steps and proceeds to step 404 where a display pattern for processing user interaction is generated. Step 406 determines whether the user interaction includes a stroke that begins at a position in a peripheral portion and ends at a position in a central portion of the display pattern. If such a stroke is not detected, step 408 waits for further user interaction.

If step 406 detects such a stroke, step 410 determines a desired page as denoted by the position in the zones display portion. Step 412 transforms input cells corresponding to a current page into input cells corresponding to the desired page. Step 414 determines whether the user resumes use of the computing device or whether the user shut down the computing device. If the user continues to interact with the computing device, step 414 returns to step 406; and if not, step 416 terminates the example steps depicted in FIG. 4.

### Example Operating Environment

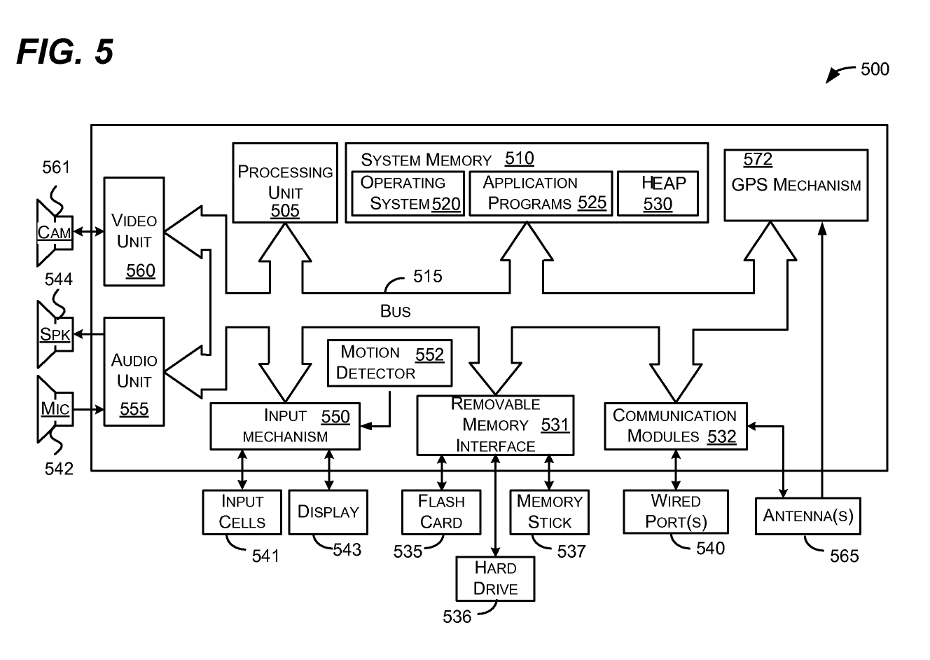

FIG. 5 illustrates an example of a suitable mobile device 500 on which aspects of the subject matter described herein may be implemented. The mobile device 500 is only one example of a device and is not intended to suggest any limitation as to the scope of use or functionality of aspects of the subject matter described herein. Neither should the mobile device 500 be interpreted as having any dependency or requirement relating to any one or combination of components illustrated in the example mobile device 500.

With reference to FIG. 5, an example device for implementing aspects of the subject matter described herein includes a mobile device 500. In some embodiments, the mobile device 500 comprises a cell phone, a handheld device that allows voice communications with others, some other voice communications device, or the like. In these embodiments, the mobile device 500 may be equipped with a camera for taking pictures, although this may not be required in other embodiments. In other embodiments, the mobile device 500 may comprise a personal digital assistant (PDA), hand-held gaming device, notebook computer, printer, appliance including a set-top, media center, or other appliance, other mobile devices, or the like. In yet other embodiments, the mobile device 500 may comprise devices that are generally considered non-mobile such as personal computers, servers, or the like.

Components of the mobile device 500 may include, but are not limited to, a processing unit 505, system memory 510, and a bus 515 that couples various system components including the system memory 510 to the processing unit 505. The bus 515 may include any of several types of bus structures including a memory bus, memory controller, a peripheral bus, and a local bus using any of a variety of bus architectures, and the like. The bus 515 allows data to be transmitted between various components of the mobile device 500.

The mobile device 500 may include a variety of computer-readable media. Computer-readable media can be any available media that can be accessed by the mobile device 500 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the mobile device 500.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, Bluetooth®, Wireless USB, infrared, Wi-Fi, WiMAX, and other wireless media. Combinations of any of the above should also be included within the scope of computer-readable media.

The system memory 510 includes computer storage media in the form of volatile and/or nonvolatile memory and may include read only memory (ROM) and random access memory (RAM). On a mobile device such as a cell phone, operating system code 520 is sometimes included in ROM although, in other embodiments, this is not required. Similarly, application programs 525 are often placed in RAM although again, in other embodiments, application programs may be placed in ROM or in other computer-readable memory. The heap 530 provides memory for state associated with the operating system 520 and the application programs 525. For example, the operating system 520 and application programs 525 may store variables and data structures in the heap 530 during their operations.

The mobile device 500 may also include other removable/non-removable, volatile/nonvolatile memory. By way of example, FIG. 5 illustrates a flash card 535, a hard disk drive 536, and a memory stick 537. The hard disk drive 536 may be miniaturized to fit in a memory slot, for example. The mobile device 500 may interface with these types of non-volatile removable memory via a removable memory interface 531, or may be connected via a universal serial bus (USB), IEEE 1394, one or more of the wired port(s) 540, or antenna(s) 565. In these embodiments, the removable memory devices 535-537 may interface with the mobile device via the communications module(s) 532. In some embodiments, not all of these types of memory may be included on a single mobile device. In other embodiments, one or more of these and other types of removable memory may be included on a single mobile device.

In some embodiments, the hard disk drive 536 may be connected in such a way as to be more permanently attached to the mobile device 500. For example, the hard disk drive 536 may be connected to an interface such as parallel advanced technology attachment (PATA), serial advanced technology attachment (SATA) or otherwise, which may be connected to the bus 515. In such embodiments, removing the hard drive may involve removing a cover of the mobile device 500 and removing screws or other fasteners that connect the hard drive 536 to support structures within the mobile device 500.

The removable memory devices 535-537 and their associated computer storage media, discussed above and illustrated in FIG. 5, provide storage of computer-readable instructions, program modules, data structures, and other data for the mobile device 500. For example, the removable memory device or devices 535-537 may store images taken by the mobile device 500, voice recordings, contact information, programs, data for the programs and so forth.

A user may enter commands and information into the mobile device 500 through input devices such as input cells 541 and the microphone 542. In some embodiments, the input cells 541 may be arranged into a key pad or keyboard. In other embodiments, the input cells 541 may be arranged around a periphery of a zones display portion of a display pattern. In some embodiments, the display 543 may be touch-sensitive screen and may allow a user to enter commands and information thereon. The input cells 541 and display 543 may be connected to the processing unit 505 through an input mechanism 550 that is coupled to the bus 515, but may also be connected by other interface and bus structures, such as the communications module(s) 532 and wired port(s) 540. It is appreciated that the input mechanism 550 comprises a cell-based input mechanism, as described herein. Motion detection 552 can be used to determine gestures made with the device 500.

A user may communicate with other users via speaking into the microphone 542 and via text messages that are entered on the input cells 541 or a touch sensitive display 543, for example. The audio unit 555 may provide electrical signals to drive the speaker 544 as well as receive and digitize audio signals received from the microphone 542.

The mobile device 500 may include a video unit 560 that provides signals to drive a camera 561. The video unit 560 may also receive images obtained by the camera 561 and provide these images to the processing unit 505 and/or memory included on the mobile device 500. The images obtained by the camera 561 may comprise video, one or more images that do not form a video, or some combination thereof.

The communication module(s) 532 may provide signals to and receive signals from one or more antenna(s) 565. One of the antenna(s) 565 may transmit and receive messages for a cell phone network. Another antenna may transmit and receive Bluetooth® messages. Yet another antenna (or a shared antenna) may transmit and receive network messages via a wireless Ethernet network standard.

Still further, an antenna provides location-based information, e.g., GPS signals to a GPS interface and mechanism 572. In turn, the GPS mechanism 572 makes available the corresponding GPS data (e.g., time and coordinates) for processing.

In some embodiments, a single antenna may be used to transmit and/or receive messages for more than one type of network. For example, a single antenna may transmit and receive voice and packet messages.

When operated in a networked environment, the mobile device 500 may connect to one or more remote devices. The remote devices may include a personal computer, a server, a router, a network PC, a cell phone, a media playback device, a peer device or other common network node, and typically includes many or all of the elements described above relative to the mobile device 500.

Aspects of the subject matter described herein are operational with numerous other general purpose or special purpose computing system environments or configurations. Examples of well known computing systems, environments, and/or configurations that may be suitable for use with aspects of the subject matter described herein include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server may be used herein, it will be recognized that this term may also encompass a client, a set of one or more processes distributed on one or more computers, one or more stand-alone storage devices, a set of one or more other devices, a combination of one or more of the above, and the like.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising, displaying a display pattern having a first portion and a second portion on which a set of input cells are configured, and when a stroke begins at a position on the second portion and ends at the first portion, modifying the set of input cells on the display pattern.

2. The method of claim 1 further comprising transforming the set of input cells into another set of input cells based upon the position on the second portion.

3. The method of claim 1 further comprising configuring another set of input cells on a periphery of the first portion.

4. The method of claim 1 further comprising displaying at least part of a functions page, a commands page, a letters page, a numbers page, a navigation page, or a custom page.

5. The method of claim 1 further comprising configuring a set of input cells for a new page.

6. The method of claim 5 further comprising mapping the new page to a zone of the second portion, and displaying page indicia on the zone.

7. The method of claim 6 further comprising upon detection of user interaction with the zone, displaying an extended view of the page indicia for the new page.

8. The method of claim 7, wherein displaying the extended view further comprises displaying tutorial data for input cells on the zone.

9. The method of claim 5 further comprising modifying the display pattern to display on the second portion the set of input cells for the new page.

10. The method of claim 1 further comprising recording a macro as a custom command, and adding the custom command to an input cell on the second portion.

11. The method of claim 1 further comprising modifying an arrangement of the set of input cells in response to user interaction.

12. The method of claim 11 further comprising moving an input cell to another zone.

13. The method of claim 1 further comprising projecting another set of input cells from an input mechanism onto zones of the second portion, and automatically configuring a new page for the other set of input cells.

14. In a computing environment, a cell-based input mechanism for a computing device, wherein the cell-based input mechanism displays a display pattern having a zones display portion and another portion, wherein the cell-based input mechanism configures a page on the display pattern in response to a stroke that begins at a zone on the zones display portion and proceeds to the other portion, wherein the page corresponds to a set of input cells operating on the cell-based input mechanism.

15. The computing device of claim 14, wherein the stroke proceeds at an input cell of the page, and the cell-based input mechanism processes an input associated with the input cell.

16. The computing device of claim 15, wherein the set of input cells comprises an arrangement of keyboard keys.

17. The computing device of claim 14, wherein the cell-based input mechanism portion displays the set of input cells as a ring on the zones display portion.

18. The computing device of claim 14, wherein the cell-based input mechanism portion displays the set of input cells on the other portion.

19. The computing device of claim 14, wherein the cell-based input mechanism portion processes user interaction for remotely controlling a larger display device.

20. One or more computer-readable media having computer-executable instructions, which when executed perform steps, comprising:
displaying a display pattern having a central portion and a peripheral portion, wherein a first set of input cells are displayed around a periphery of the central portion;
detecting a stroke that begins at a zone on the peripheral portion displaying page indicia and ends on the central portion;
transforming the first set of input cells on the display pattern into a second set of input cells corresponding to the page indicia; and
if the stroke is repeated, processing strokes with respect to a plurality of input cells the second set of input cells and if not, processing a selection of an input cell of the second set of cells.
